(19) United States
(12) Patent Application Publication
(10) Pub. No.: US 2004/0252993 A1
(43) Pub. Date: Dec. 16, 2004

(54) Camera built-in mirror equipment

(76) Inventor: Hidenori Sato, Shizuoka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/311,140

(22) PCT Filed: Apr. 5, 2002
(86) PCT No.: PCT/JP02/03478

(51) Int. Cl. G03B 1/00

(52) U.S. Cl. 396/661

(57) ABSTRACT

Infrared camera 5, infrared luminescence equipment 2, and shutter synchronous luminescence drive 7 are arranged in mirror case 6 at the back side of cold mirror 3, infrared luminescence equipment 2 synchronizes with shutter operation of the infrared camera 5 by the shutter synchronous luminescence drive 7, to do intermittent luminescence operation. And clear and exact stable photography picture is obtained without being influenced by disturbance light, without a driver and a fellow passenger who are a photographic subject having sense of incongruity in any way, without making them conscious of existence of an infrared camera also.

### TECHNICAL FIELD OF THE INVENTION

The present invention relates to a mirror equipment with a built-in camera having an infrared camera contained in a mirror case, and more specifically, relates to a mirror equipment with a built-in camera for vehicles which acts preferably as the monitor of the driver and fellow passenger of a car.

### DESCRIPTION OF THE PRIOR ARTS

Conventionally, mirror image pick-up equipment has been known which makes up of camera reflecting incidence light partially, while receiving partially penetrated light with a half mirror, in combination with mirror. Also, an equipment which includes image pick-up means in the inside of the case of reflectors such as a room mirror for vehicles so as to supervise the interior of a room photoed with a light which is penetrated the reflector, is known per se, and disclosed in JP-A-12-264128.

Although the half mirror, transmissivity and reflectance of which is about 50% respectively is used with the mirror image pick-up equipment using the conventional half mirror. Also, it is hard to check a clear reflective image by visual examination by the mirror with being about 50% of reflectance. In addition, at 50% of transmissivity, the picture caught with image pick-up equipment by the light which penetrated the half mirror also becomes dark, and especially becomes hard to see in a dimly lighted place. If lighting is attached to a camera in order to compensate the above-described problem, it is noticeable that camera is present there, whereas if being attached around being different from a camera, it is not preferable in respect of a design and expense.

A mirror image pick-up equipment thus arranged is provided in vehicles as a monitor of the vehicle compartment which acts as the monitor of a driver and a fellow passenger. Then, a driver and a fellow passenger are made to feel a sense of incongruity. In addition, lighting is too dazzling to be accepted. In order to prevent this problem, if a highly sensitive camera is attached therein, it becomes expensive.

Also; description is made referring to the above-described conventionally known rear view mirror for vehicles, such that:

to achieve a reliable photoing with a CCD camera without making a passenger seat crew member conscious of it, or without spoiling a design thereof; in addition, to regard the main part of a reflector as a so-called cold mirror through which infrared rays penetrate and other light is reflected as well as regarding an image pick-up means as an infrared camera; and along with this, to supervise the infrared rays bydetecting near-infrared rays emitted from a crew member's body; further, to determine the standard part for a judgment in an infrared luminescence machine provided in the predetermined position in vehicles in order to judge whether the position of an infrared camera is proper.

However, when a mirror image pick-up equipment—is intended to be added more advanced features, raising added value thereof, and used as a monitor for a safety of a driver in the car, for such as nap prevention of a driver etc., there arises a necessity of picturizing the photographic subject in the car such as a direction or motion of a face or an eyelid more vividly. Namely, picturization by the infrared rays emitted from a crewmember's body is not enough.

To overcome this problem, the illumination light for photography is required. However, if lighting equipment is formed in the car especially when using this kind of mirror image pick-up equipment as a monitor for vehicles, unnaturalness and, sense of incongruity are given to the driver and fellow passenger who are a photographic subject. Then, this is not preferable in respect of a design also.

In addition, when used as picture information which judges nap states of such as a driver, by carrying out image processing of the photography picture obtained by being illuminated from optically different direction, a photography camera and illumination light for photography irradiated from different direction will produce a shade partially to faces, such as a driver who is a photographic subject, and will become a noise as picture information.

Furthermore, if light is made to always emit and illuminate, luminescence equipment poses a below-mentioned problem. That is, since there are many amounts of energy consumption resulting in a reduction of the luminous intensity of the illumination light, the image pick-up stabilized by disturbance light is not obtained.

This invention aims at overcoming the problem of the above conventional art to achieve a built-in camera, wherein a photograph can be taken without giving sense of incongruity to a driver and fellow passenger who are photographic subjects even if used as a monitor for vehicles, and fine operation of a photographic subject is photographed vividly and correctly without a noise increases when image processing is carried out, and reflective capability as a usual mirror is not reduced.

### SUMMARY OF THE INVENTION

In order to overcome the above-described problem, this invention provides a mirror equipment for a vehicle with a built-in camera, which has a cold mirror equipped in a mirror case, and in which light in the range of from near-infrared to infrared region emitted with an infrared luminescence equipment is irradiated through the cold mirror onto a photographic subject in the vehicle and the capotric light is photoed with the infrared camera capable of taking photograph,

said infrared camera and said infrared luminescence equipment being arranged in the mirror case at the back side of the cold mirror.

This invention provides a mirror equipment for a vehicle with a built-in camera, which has a cold mirror equipped in a mirror case, and in which light in the range of from near-infrared to infrared region emitted with an infrared luminescence equipment is irradiated through the cold mirror onto a photographic subject in the vehicle and the capotric light is photoed with the infrared camera capable of taking photograph, said infrared luminescence equipment performing intermittent luminescence operation with a shutter synchronous luminescence drive synchronizing with shutter operation of an infrared camera, and the infrared camera, infrared luminescence equipment,and the shutter synchronous luminescence drive being arranged in the mirror case at the back side of the cold mirror.

The cold mirror is characterized by being a multilayer functional film made up of coating of SiO₂ thin film and TiO₂ thin film growing into the multilayer in one side of a transparent substrate glass.

The cold mirror is characterized by being what is used as a rearview mirror in the left of a car.

The infrared camera corresponds to an infrared digital camera, characterized by presenting the pattern recognition in image-processing equipment regarding the photoed picture signal as picture information.

The shutter of infrared camera is characterized by performing shutter operation at intervals of once per 10-60 seconds, the shutter speed being set at 1/250 to 100000 seconds.

### BRIEF DESCRIPTION OF THE DRAWINGS

FIG. 1 is a block diagram showing the constitution of the embodiment of mirror equipment with a built-in infrared camera according to this invention.

FIG. 2 is an explanatory view of the embodiment of mirror equipment with a built-in infrared camera according to this invention.

FIG. 3 is an exemplary view showing the example of manufacture of a multilayer film as one aspect of a cold mirror used for mirror equipment with a built-in infrared camera.

FIG. 4 is a view showing the wavelength characteristic of a multilayer film.

FIG. 5 is an explanatory view showing the relation between the timing of the opening operation of the shutter of an infrared camera, and the timing of infrared luminescence equipment.

### BEST MODE FOR CARRYING OUT THE INVENTION

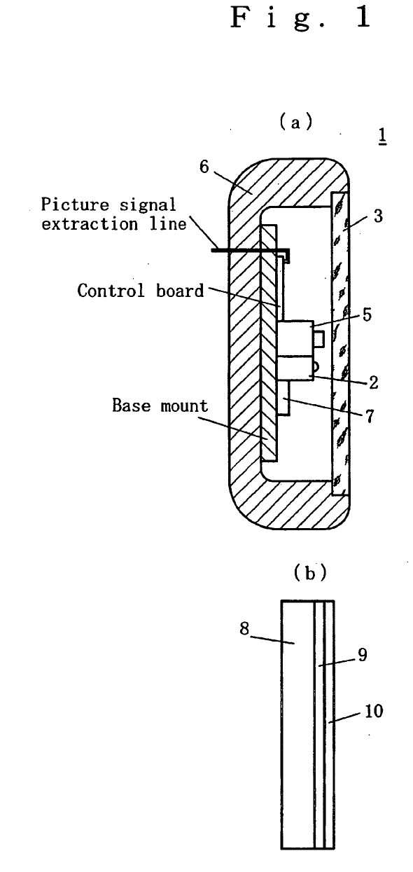

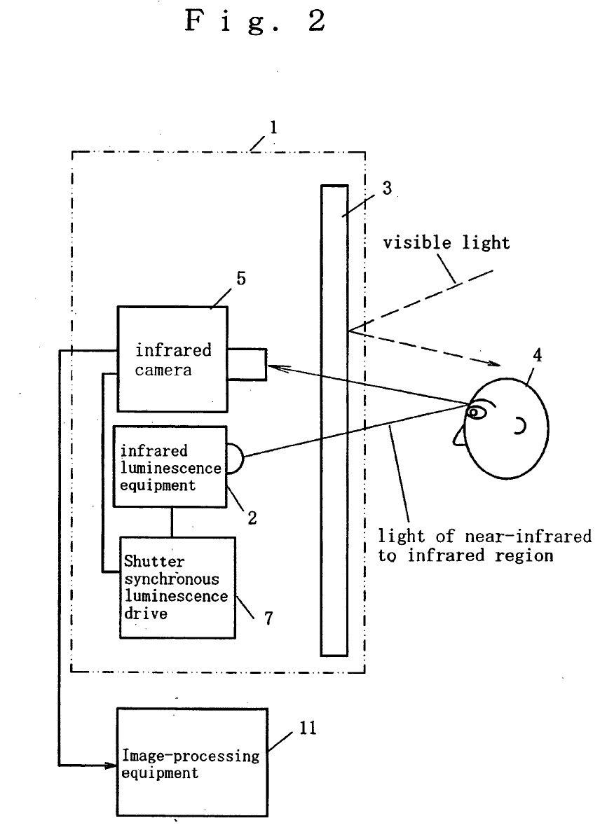

The present invention will now be specifically explained in conjunction with the drawings. FIG. 1 and FIG. 2 are block diagrams of the exemplary embodiment of this invention. The mirror equipment with a built-in camera according to this invention relates to mirrors for cars, such as a rearview mirror provided in the interior of a room of a car.

According to the outline of the mirror equipment 1 with a built-in camera of this invention, light in the range of near-infrared to infrared region emitted with infrared luminescence equipment 2 is irradiated through cold mirror 3 onto the photographic subjects 4, such as a driver in the car and a fellow passenger. Then, the catoptric light is photoed with the infrared camera 5 capable of taking photograph with the light in the range of from near-infrared to infrared region.

As shown in FIG. 1(a), this mirror equipment 1 with a built-in camera is equipped with mirror case 6; cold mirror 3 held at this mirror case 6; infrared luminescence equipment 2 formed on base mount within the mirror case 6 at the back side of the cold mirror 3; infrared camera 5 and shutter synchronous luminescence drive 7. Accordingly, infrared luminescence equipment 2 and infrared camera 5 are hidden by the reverse side of the cold mirror 3, so as to be arranged in such a manner that it cannot be seen from the outside.

As shown in FIG. 1(b), the cold mirror 3 is formed on the transparent substrate glass 8 used as a base material, by coating a multiplayer comprising SiO₂ thin film 9 in combination with TiO₂ thin films 10. In the cold mirror shown in FIG. 1(b), SiO₂ thin film 9 and TiO₂ thin film are coated as two layers. However, according to a difference in each film thickness of SiO₂ thin film 9 or TiO₂ thin film 10 and the number of layers, the multilayer film which has the arbitrary wavelength characteristics can be obtained.

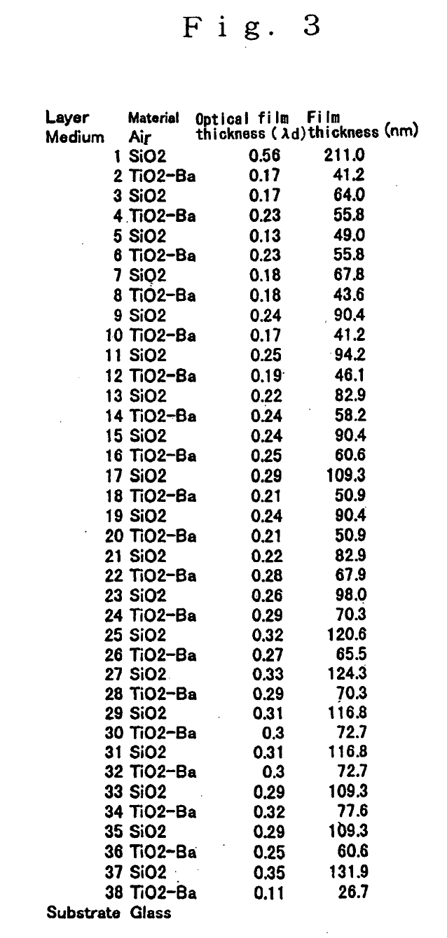

FIG. 3 is a diagram showing the example of manufacture of the multilayer film as one aspect of such a cold mirror.

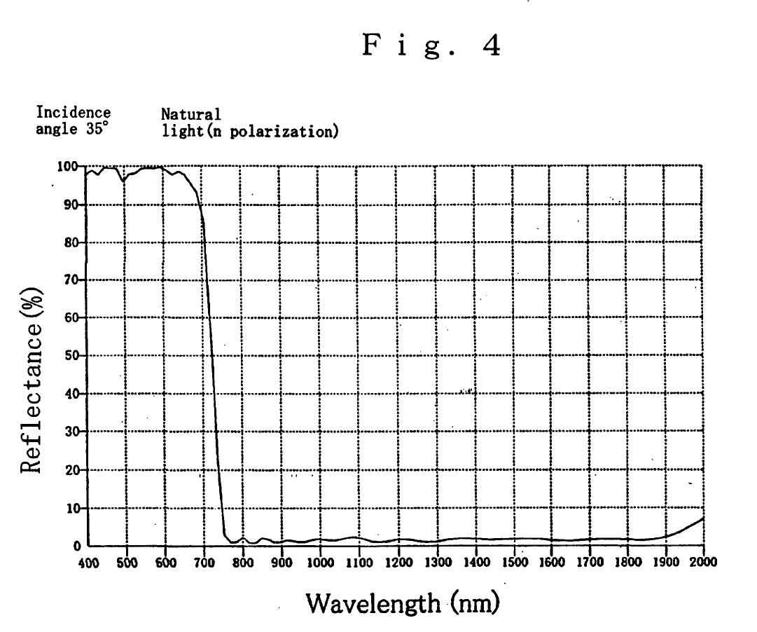

This multilayer comprises a multilayer film in such a manner that SiO₂ thin film and the TiO₂-Ba thin film are laminated repeatedly from the air side (shown as “Air” in the drawing) to substrate glass which is a base mount (shown as “Substrate” in the drawing), growing into the multilayer film of 1 to 38 layers (shown as “1 to 38” in the drawing). Furthermore, the optical film thickness (λd) and film thickness (nm) are as being shown in FIG. 3. FIG. 4 is a view showing the wavelength characteristic of a multilayer film. In the cold mirror having the characteristics as shown in FIG. 4, reflectance is about 99% for the light with a wavelength of 700 nm or less. Whereas, reflectance becomes about 5% for the light with a wavelength in excess of 700 nm inclusive of the light in the range of near-infrared to infrared region. The cold mirror is penetrated in the light of such wavelength.

In short, cold mirror 3 of mirror equipment 1 with a built-in infrared camera reflects visible light, and the cold mirror which makes the light of the wavelength in the range of near-infrared to infrared region is used therein.

Infrared luminescence equipment 2 has a photogene comprising the light emitting diode which emits light having a wavelength in the range of near-infrared to infrared region. For example, the infrared light emitting diode using GaAs as an infrared light emitting diode which emits light having a wavelength of infrared region is used.

Infrared camera 5 corresponds to an infrared electronic-type digital camera, for example and the infrared camera of the monochrome which responds to the light of the wavelength in the range of near-infrared to infrared region is used, having CCD and CMOS as the pixel thereof. This infrared camera 5 has the electronic shutter controlled by the control circuit provided in the control board. This shutter operates intermittently, for example at intervals of 30 seconds, and shutter speed thereof is set at 1/250 to 1/1000000 seconds.

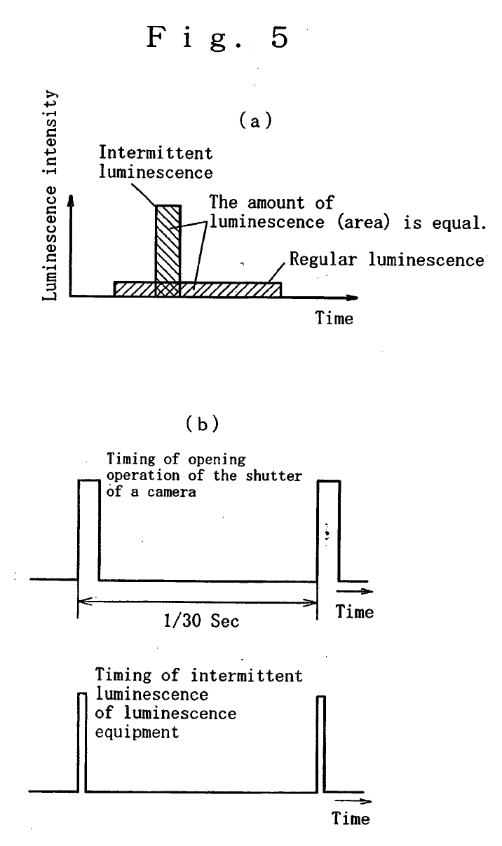

FIG. 5 is an explanatory view showing the relation between the timing of opening operation of the shutter of the infrared camera 5 of this invention, and the timing of infrared luminescence equipment 2. If the light emitting diode included in infrared luminescence equipment 2 always emits light as shown in FIG. 5 (a), the power (amount of luminescence) is too small to obtain a sufficient amount of photographic light. Also, in this case, it is not necessarily preferable in the respect such that much heat dissipation is involved therein with the result that the whole equipment is heated and energy is exhausted. Therefore, in order to raise power and to lessen consumption of energy from heat dissipation, it is good to make the light switch on intermittently.

Hereupon, shutter synchronous luminescence drive 7 is provided in mirror equipment 1 with a built-in infrared camera according to this invention, thereby allowing the timing when a shutter of infrared camera 5 opens and photos a photographic subject 4 and timing of luminescence of infrared luminescence equipment 2 to be synchronized as shown in FIG. 5(b).

Incidentally, the picture signal photoed with the infrared camera 5 is sent to an image-processing equipment by the picture signal extraction line. Then, processing of pattern recognition etc. is performed in image-processing equipment according to various use purposes of the mirror equipment 1 with a built-in infrared camera of this invention.

For example, when used for a driver's nap preventive measures as hereinafter referred, as shown in FIG. 2, the picture signal photoed with the infrared camera 5 is sent and patternized by image-processing equipment 11 as picture information, and is compared with the standard pattern in a driver's sleepiness mode, and the judgment of whether or not a driver is in sleepiness mode is presented.

Referring to an action of mirror equipment 1 with a built-in infrared camera with employment of above-described structure, in the case when this mirror equipment 1 with a built-in infrared camera used as a rearview mirror loaded in the interior of a room of a car will be explained. This mirror equipment 1 with a built-in infrared camera is attached in the same manner as a usual rearview mirror.

Mirror equipment 1 with a built-in infrared camera can be used for the purpose of such as preventive measures against a driver's looking aside while driving (driving while continuing looking aside more than fixed time.), a dozing off while driving, or safety measures for a fellow passenger, especially for a small child or an old man, and a measure against a taxi holdup. Thus, various kinds of use can be accommodated while the function as a usual rearview mirror is also demonstrated.

In the mirror equipment 1 with a built-in infrared camera, adjustment is performed beforehand in such a manner that the irradiation direction of infrared luminescence equipment 2, and the photography direction of infrared camera 5 corresponds to for example, the direction of a driver, the direction of a passenger seat (example: the direction of an infant seat), and the direction of the customer of a taxi, etc.

With this mirror equipment 1 with a built-in infrared camera, only the wavelength in the range of near-infrared to infrared region penetrates the cold mirror 3, and visible light is reflected. Therefore, the light having the wavelength in the range of near-infrared to infrared region emitted from luminescence equipment 2 passes through cold mirror 3 to be irradiated onto the photographic subject 4. Then, the catoptric light passes along the cold mirror 3 again, is received and photoed with an infrared camera 5. Since visible light is almost reflected by the cold mirror 3, functions as a usual rearview mirror is possible.

In infrared camera 5, shutter opens once, during which duration picture signal is taken in to all the pixels of a camera. In case of CCD, it is outputted by transmission, and, in case of CMOS, it is outputted by change one by one, and this picture signal is sent to external image-processing equipment 11, thereby constituting one screen, pattern recognition is presented.

For example, in case of a driver's looking aside or nap preventive measures, infrared camera 5 determines a photographic subject 4 intended to be a target thereof as a driver's face or whole face. Then, the direction of a driver's face or an eyelid close condition etc. is photoed, and the picture is patternized with image-processing equipment 11. This patternized picture is compared with the standard pattern of the sleepiness operation mode or looking-aside-while-driving mode where eyelids are likely to close. Then, looking aside while driving and sleepiness operation are judged immediately.

Since-infrared camera 5 and infrared luminescence equipment 2 are hidden in the back side of the cold mirror 3 with this mirror equipment 1 with a built-in infrared camera, those who become photographic subjects, such as a driver and a fellow passenger are not especially conscious of being monitored with the infrared camera 5, compared with the case where the usual rearview mirror is used, and do not feel sense of incongruity at all, either.

Also, since visible light is not used as a photographic light, but the light of the wavelength in the range of near-infrared to infrared region is used, a driver and a fellow passenger are not dazzled, and do not think that the irradiation light from infrared luminescence equipment 2 is unpleasant, thereby allowing comfortable operation and drive to be attained.

In the vehicle, since it is dark, especially in the night, it is not expectable to take a photograph vividly, even if it takes a photograph with natural light using the camera for photographing with the usual visible light. However, if the light of the wavelength in the range of near-infrared to infrared region is irradiated onto a photographic subject and photed with an infrared camera 5, a clear photography picture will be obtained.

Furthermore, when photoing a driver, a fellow passenger, etc. who are photographic subjects 4, if infrared luminescence equipment 2 and infrared camera 5 are separated, since light can be irradiated from slant or a transverse direction onto photographic subjects 4, the place which serves as a shadow by the unevenness of a driver's face is generated. If the shadow made through the nose arises to an eye, the eye is not discriminable. This may be considered as a causative factor of inaccuracy in pattern recognition, and inconvenience will arise.

In the mirror equipment 1 with a built-in infrared camera of this invention, an infrared camera 5 and infrared luminescence equipment 2 are arranged in the mirror case 6. Therefore, infrared camera 5 and infrared luminescence equipment 2 are mutually close, generating of the shade by the irradiation light etc. is prevented. Consequently, the picture information for exact pattern recognition can be obtained.

Incidentally, if mirror equipment 1 with a built-in infrared camera according to this invention is used as a rearview mirror to monitor a driver, the driver who is a photographic subject 4 is intended to take various positions to a rearview mirror by setting the height, height sitting down, and a seat etc. However, if the angle for use of a rearview mirror is adjusted so that a driver may look at the spectacle from a back window with a rearview mirror even if a rearview mirror has various position relation with a driver, the relative angle relation between the direction of a reflector glass and a driver's face is substantially constant.

Mirror equipment 1 with a built-in infrared camera according to this invention is arranged in such a manner that infrared luminescence equipment 2 and infrared camera 5 are set in the mirror case 6. Considering the above-described relative angle relation, if the direction of the infrared luminescence equipment 2 or direction of the infrared camera 5 to the direction of cold mirror is set in the direction of a photographic subject, even if different way of sitting down is adopted depending on different drivers, when the angle for use of a rearview mirror is adjusted in a above-described manner, the relation of a driver's face as a photographic-subject 4 to the infrared camera 5 becomes a relation which always substantially counters the front. The angle-conditions of image recognition can be thus adjusted somewhat uniformly.

Embodiments of the mirror equipment with a built-on infrared camera according to the present invention have been described above on the basis of specific examples. However, it should be noted that the present invention is not restricted to such examples., and many examples can be made within the technical scope of the appended claims.

According to the above-described invention, by employment of the arrangement in such a manner that an infrared camera, infrared luminescence equipment, and a shutter synchronous luminescence drive are arranged in the mirror case in the backside of a cold mirror, and further, luminescence operation is performed with a shutter synchronous luminescence drive synchronizing with shutter operation of an infrared camera. This causes the below-mentioned effect.

(1) Sense of incongruity is not given at all to the driver and fellow passenger who are photographic subjects, without being conscious of existence of an infrared camera and infrared luminescence equipment. Dazzle is not felt about the irradiation light from infrared luminescence equipment, either, and, moreover, there is also little energy consumption.

(2) There is little influence by disturbance light and the clear and exact stable photography picture is obtained about fine operation of a photographic subject. When image processing is carried out, the picture information with few noises which makes exact pattern recognition possible can be offered.

(3) Reflective capability as a usual mirror is not reduced.

### Industrial Applicability

Since this invention is arranged in accordance with the above-described construction and effects, the mirror equipment with a built-in camera according to this invention fits the mirror equipment with a built-in camera which contained the infrared camera in the mirror case, and especially the mirror equipment for vehicles with a built-in camera for acting as the monitor of the driver and fellow passenger of a car.

1. A mirror equipment for a vehicle with a built-in camera, which has a cold mirror equipped in a mirror case, and in which light in the range of from near-infrared to infrared region emitted with an infrared luminescence equipment is irradiated through the cold mirror onto a photographic subject in the vehicle and the capotric light is photoed with the infrared camera capable of taking photograph,
said infrared camera and said infrared luminescence equipment being arranged in the mirror case at the back side of the cold mirror.

2. A mirror equipment for a vehicle with a built-in camera, which has a cold mirror equipped in a mirror case, and in which light in the range of from near-infrared to infrared region emitted with an infrared luminescence equipment is irradiated through the cold mirror onto a photographic subject in the vehicle and the capotric light is photoed with the infrared camera capable of taking photograph, said infrared luminescence equipment performing intermittent luminescence operation with a shutter synchronous luminescence drive synchronizing with shutter operation of an infrared camera, and the infrared camera, infrared luminescence equipment, and the shutter synchronous luminescence drive being arranged in the mirror case at the back side of the cold mirror.

3. The mirror equipment for a vehicle with a built-in camera as set forth in claim 1 or 2, wherein said cold mirror comprises a multilayer film in such a manner that an SiO₂ thin film and a TiO₂-Ba thin film are laminated repeatedly growing into the multilayer films.

4. The mirror equipment for a vehicle with a built-in camera as set forth in claim 1, 2, or 3, wherein said cold mirror is used as a rearview mirror of a car.

5. The mirror equipment for a vehicle with a built-in camera as set forth in claim 1, 2, or 3, wherein said infrared camera is an infrared digital camera, which presents the pattern recognition in image-processing equipment regarding the photoed picture signal as picture information.

6. The mirror equipment for a vehicle with a built-in camera as set forth in claim 1, 2, or 3, wherein said shutter of infrared camera performs shutter operation at intervals of once per 10-60 seconds, the shutter speed being set at 1/250 to 100000 seconds.
